(19) United States
(12) Patent Application Publication
(10) Pub. No.: US 2017/0222939 A1
(43) Pub. Date: Aug. 3, 2017

(54) ADAPTIVE INTER-FRAME GAP REDUCTION IN MULTIMEDIA OVER COAX ALLIANCE (MOCA) NETWORKS

(71) Applicant: MaxLinear, Inc., Carlsbad, CA (US)

(72) Inventor: Sridhar Ramesh, Irvine, CA (US)

(21) Appl. No.: 15/423,293

(22) Filed: Feb. 2, 2017

Related U.S. Application Data
(60) Provisional application No. 62/290,264, filed on Feb. 2, 2016.

(51) Int. Cl. H04L 12/805; H04L 12/28

(52) U.S. Cl. CPC H04L 47/365; H04L 12/2801

(57) ABSTRACT

Systems and methods are provided for utilizing adaptive inter-frame gap reduction in Multimedia over Coax Alliance (MoCA®) networks. A network node that is configured as network controller within a Multimedia over Coax Alliance (MoCA®) network may receive communication timing related information associated with each of a plurality of network nodes in the MoCA network; assess based on the communication timing related information, communication timing for each pair of network nodes in the plurality of network nodes; and adaptively configure communications between each pair of network nodes in the plurality of network nodes based on the assessing. The configuring may comprise adjusting timing related parameters or fields in packets. The timing related parameters or fields may comprise inter-frame gap (IFG) fields in physical layer (PHY) packets. The communication timing related information may comprise ranging information or ranging-based timing information determined based on the ranging information.

### CLAIM OF PRIORITY

This patent application makes reference to, claims priority to and claims benefit from U.S. Provisional Patent Application Serial No. 62/290,264, filed Feb. 2, 2016. The above identified application is hereby incorporated herein by reference in its entirety.

### TECHNICAL FIELD

Aspects of the present disclosure relate to communications. More specifically, certain implementations of the present disclosure relate to methods and systems for an adaptive inter-frame gap reduction in Multimedia over Coax Alliance) (MoCA®) networks.

### BACKGROUND

Various issues may exist with conventional systems and/or methods for managing communications in Multimedia over Coax Alliance (MoCA®) networks. For example, conventional approaches for managing inter-frame gaps in MoCA networks may be costly, cumbersome, and/or inefficient. Further limitations and disadvantages of conventional and traditional approaches will become apparent to one of skill in the art, through comparison of such systems with some aspects of the present disclosure as set forth in the remainder of the present application with reference to the drawings.

### BRIEF SUMMARY

System and methods are provided for an adaptive inter-frame gap reduction in Multimedia over Coax Alliance (MoCA®) networks, substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF SEVERAL VIEWS OF THE DRAWINGS

FIG. 1 illustrates an example in-home Multimedia over Coax Alliance (MoCA®) network.

FIG. 2 illustrates example Multimedia over Coax Alliance (MoCA®) physical (PHY) layer packet structures.

FIG. 3 illustrates an example Multimedia over Coax Alliance (MoCA®) arrangement that may supports and utilize adaptive inter-frame gap (IFG) reduction.

FIG. 4 illustrates a flowchart of an example process for utilizing adaptive inter-frame gap (IFG) management in a Multimedia over Coax Alliance (MoCA®) network.

### DETAILED DESCRIPTION OF THE INVENTION

As utilized herein the terms “circuits” and “circuitry” refer to physical electronic components (e.g., hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y and/or z” means “one or more of x, y, and z.” As utilized herein, the term “exemplary” means serving as a non-limiting example, instance, or illustration. As utilized herein, the terms “for example” and “e.g.,” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled or not enabled (e.g., by a user-configurable setting, factory trim, etc.).

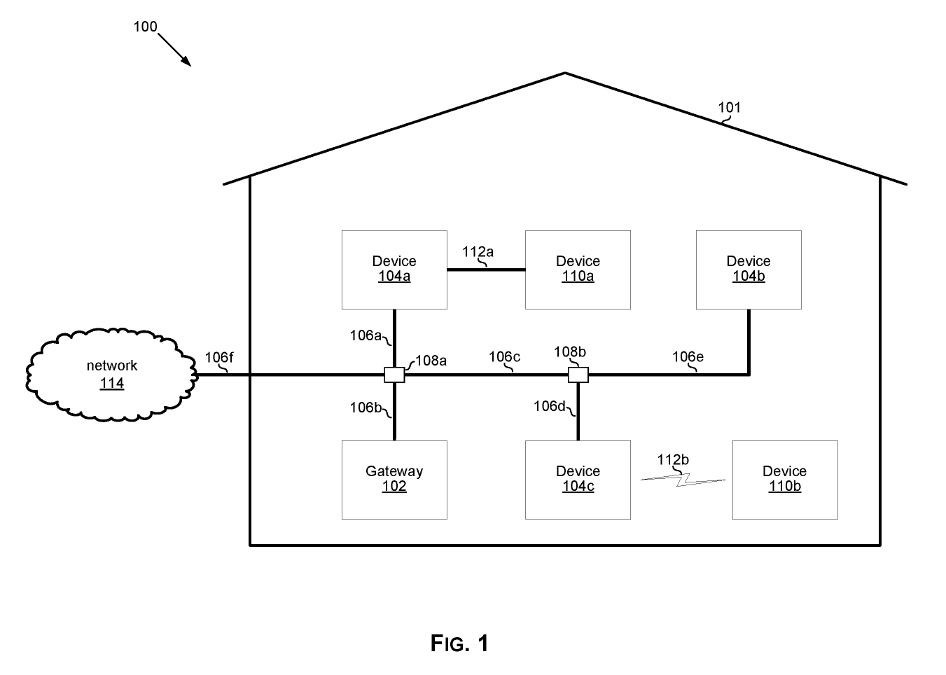

FIG. 1 illustrates an example in-home Multimedia over Coax Alliance (MoCA®) network. Shown in FIG. 1 is a MoCA based home network 100, connected to an external network 114.

The home network 100 comprises a plurality of devices connected within particular premises 101 (e.g., a home, multi-unit residence, etc.). The home network 100 may comprise, for example, a gateway device 102 and one or more networks (e.g., network devices 104a-104c and 110a-110b, as shown in the example implementation depicted in FIG. 1).

The various devices in the home network 100 may be connected via wired and/or wireless connections. For example, the gateway device 102 and the network devices 104a-104c may be coupled via links 106a-106d and splitters 108a-108b, and the network devices 110a-110b may be coupled to the network devices 104a and 104c via links 112a and 112b, respectively.

Each of the links 106a-106f may comprise wired cabling, optical cabling, and/or wireless links. In an example implementation, each of the links 106a-106f may comprise coaxial cabling. The splitter 108a may be operable to electrically couple links 106a, 106b, 106c, and 106f such that the signal on each of these four links is substantially the same. The splitter 108b may be operable to electrically couple links 106c, 106d, and 106e such that the signal on each of these three links is substantially the same.

Each of the gateway device 102 and the network devices 104ᵢ and 110ᵢ may comprise suitable circuitry for implementing various aspects of the present disclosure. For example, each of the gateway device 102, the network devices 104ᵢ, and the network devices 110ᵢ may comprise one or more of communication circuitry for handling transmission and/or reception of signals (e.g., over wired and/or wireless connections), processing circuitry for processing data, managing operations, control circuitry, components, sub-systems, etc., and storage circuitry for storing data (including, e.g., instructions and programs used in other circuitry, such as processing circuitry). In this regard, each of the gateway device 102 and the network devices 104ᵢ and 110ᵢ may comprise suitable circuitry for facilitating connectivity and/or communication within the home network 100, performing various tasks and services, and/or handling of data (e.g., multimedia content).

For example, the gateway device 102 may comprise suitable circuitry operable to communicate over the links 106a-106f. The circuitry of the gateway device 102 may also be operable to communicate with network 114 (e.g., a CATV network, a DSL network, a satellite network, etc.). The gateway device 102 may be, for example, a set-top box or gateway operable to receive data from the network 114 via the links 106f and 106b, process the received data, and convey the processed data to the network devices 104a-104c via the links 106a-106e.

Each of the network devices 104a-104c may comprise suitable circuitry operable to communicate over the links 106a-106e. The network device 104c may be, for example, a wireless access point operable to convert between the network protocols (e.g., MoCA) utilized on the links 106b-106e and the network protocols (e.g., IEEE 802.11) utilized on the link 112b. The network device 104a may be, for example, a network adaptor operable to convert between the network protocols (e.g., MoCA) used on the links 106b-106e, and the network protocols (e.g., HDMI or USB) used on the link 112a.

Each of the network devices 110a and 110b may comprise suitable circuitry operable to receive data (including, e.g., media content) via the links 112a and 112b, respectively. Each of the network devices 110a and 110b may be, for example, an end-point such as a television or personal computer.

In an example implementation, the home network 100 may be configured to support Multimedia over Coax Alliance (MoCA®) based connections and/or communications. In this regard, the gateway device 102 and the network devices 104a-104c may be configured to setup connections and communicate signals (carrying, e.g., content, control messaging, etc.), over the links 106b-106e, in accordance with MoCA standards. In such implementation, one of the devices (e.g., the gateway device 102) may function as a network coordinator (NC) of the MoCA network, controlling and/or coordinating MoCA related functions in the remaining network nodes. In this regard, the gateway device 102 may be operable to perform the various tasks assigned to the MoCA NC, such as in accordance with applicable standards or specifications.

In operation, the home network 100 may be configured to support MoCA based connectivity and/or communications. In this regard, various devices in the home network 100 may utilize MoCA based communications, over coax cabling 106, such as to facilitate exchange of data (e.g., multimedia content, control information/messaging, etc.) among the devices.

The MoCA based communications may be performed and/or managed in conformity with particular criteria, attributes, etc., such as in accordance with applicable standards, user preferences, and the like. In this regard, exchanged data may need be processed (e.g., modulated, encrypted, etc.) in particular manner; the data may be embedded into transmitted signals in particular manner (e.g., embedded in predefined structures, using predefined encapsulation structures, etc.); the signals may be transmitted in particular manner (e.g., timing constraints as set forth by the MoCA network coordinator); and the communication may need to meet particular conditions (e.g., latency, packet loss, etc.).

For example, the exchanged data may be embedded into compliant MoCA physical (PHY) layer packets. These MoCA PHY layer packets may include portions that correspond to the data itself, as well as portions that are used to facilitate the MoCA transmission. In addition to the actual data, the MoCA PHY layer packets may include, for example, portions for carrying information relating to the transmission (to enable the receiving devices to successfully handle the packets). Further, MoCA transmissions may incorporate use of idle periods between packets, to allow devices to prepare for reception of next packets. Thus, MoCA PHY layer packets may comprise inter-frame gaps (IFGs), to account for these idle periods.

As MoCA technology evolves, improvements may be introduced in handling (including, e.g., processing, embedding, etc.) the exchanged data. In this regard, data may be embedded and/or packaged more efficiently, for example, resulting in reduction of time required for transfer of same amount of data. For example, channel bonding (and improvements thereto) may be used to improved efficiency of data transfer. This may result in “reduction” in time required to transfer the same amount of data (and thus, smaller data portions in the MoCA PHY layers). The remaining portions of the MoCA PHY layer packets, however, would remain the same. In other words, the MoCA PHY layer packets may have the same (or substantially same) overhead (e.g., non-data portions in PHY packets) even as the data portions shrink, resulting in undesirable inefficiencies.

Accordingly, in various implementations in accordance with the present disclosure, measures may be taken to improve efficiencies by reducing non-data related elements of transmissions, to improve overall efficiency. For example, inter-frame gaps (IFGs) may be managed in adaptive manner, such as to enable adjusting them (e.g., to reduce them) in some instances, resulting in improve overall data transfer efficiency in MoCA networks. This is described in more details with respect to the following figures.

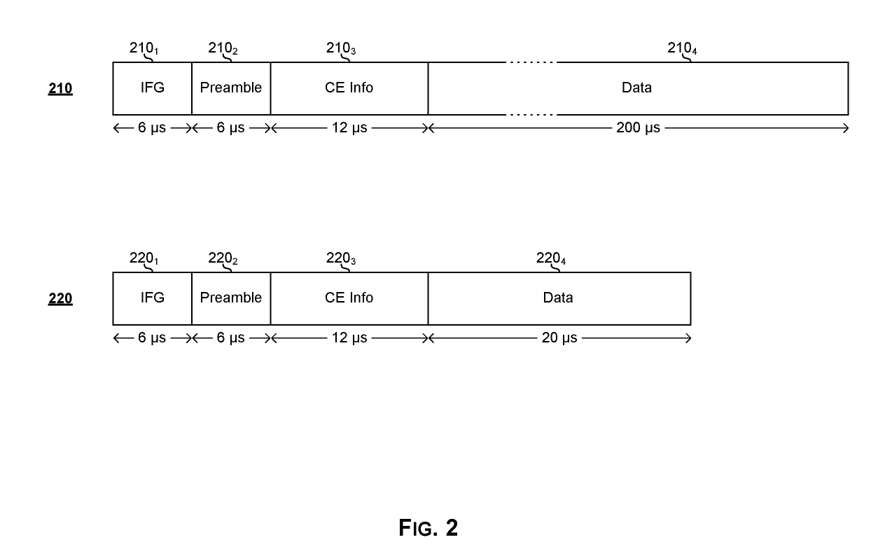

FIG. 2 illustrates example Multimedia over Coax Alliance (MoCA®) physical (PHY) layer packet structures. Shown in FIG. 2 are packets 210 and 220.

The packets 210 and 220 may correspond to MoCA based physical (PHY) layer packet bursts. The packet 210 may comprise an inter-frame gap (IFG) field 210₁ (providing guard period between packets, as described above), at its start; followed by a preamble field 210₂ (carrying various information required for handling the packet—e.g., delineating the start of the packet; followed by a channel estimation (CE) information field 210₃ (comprising information relating to channel estimation); and followed by a data (symbols) field 210₄, in which the actual data is carried. The data may be embedded in accordance with MoCA standards. In some instances, channel-bonding may be used, and as such generating the data for the PHY packets may comprise application of MSDU (MAC service data unit) aggregation.

The different fields may be assigned particular lengths (e.g., durations during transmission), as required to carry the data embedded therein and/or to ensure that the corresponding functions are performed properly. For example, as shown in FIG. 2, the IFG field 210₁ may have a 6μs duration; the preamble field 210₂ may have a 6 μs duration; the CE information field 210₃ may have a 12 μs duration; and the data field 210₄ (as shown in the example illustrated in FIG. 2) may have about a 200 μs duration.

As noted above, as MoCA evolves, data handling techniques may be modified to improve data transfer efficiencies. Thus, the same amount of data may be transferred in less time. This is demonstrated in packet 220, which may comprise a substantially similar structure—e.g., also comprising an IFG field 220₁, a preamble field 220₂, a CE information field 220₃, and a data field 220₄, which may be similar, respectively, to the IFG field 210₁, the preamble field 210₂, the CE information field 210₃, and the data field 210₄.

As illustrated in FIG. 2, enhancement in data handling may allow for improvements in data transfer (e.g., 10× faster for same data amount), thus the data field 220₄ may require a duration of only about 20 μs to transfer the same amount of data as in data field 210₄. However, without any changes in the remaining, non-data components (e.g., with each of the IFG field 220₁, the preamble field 220₂, and the CE information field 220₃ having the same duration as the IFG field 210₁, the preamble field 210₂, and the CE information field 210₃, respectively), the improvement actually achieved may be only ˜5× ((200+6+6+12)/(20+6+6+12)), resulting in actual overall efficiency of only ˜50%.

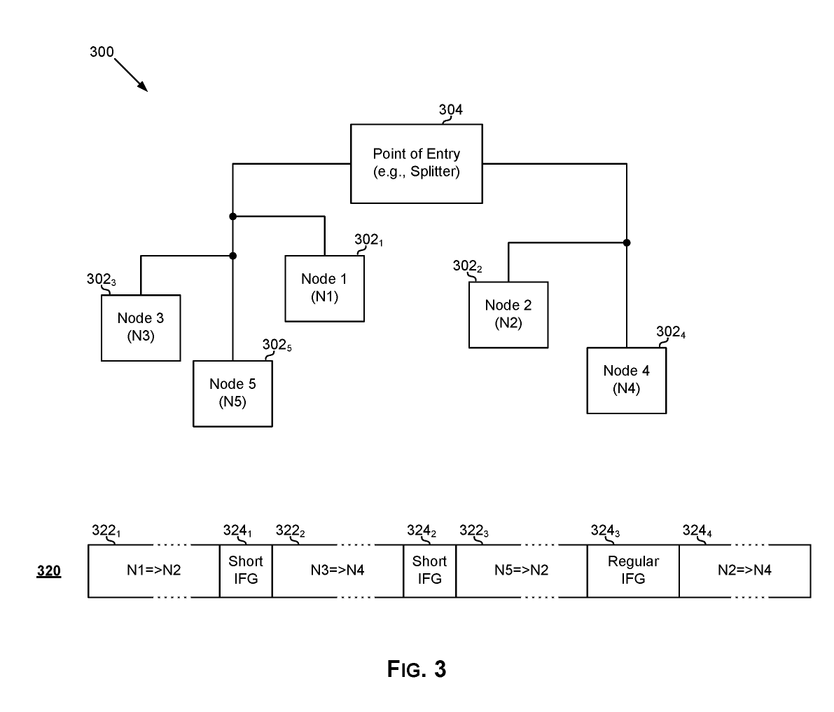

Accordingly, the overall efficiency may be improved (increased) by reducing the duration of some of the non-data components (overheads) in PHY packets, such as by reducing IFG and/or preamble overheads per burst. For example, with respect to IFGs, an adaptive management scheme may be used to allow adaptive setting of IFG fields in (between) PHY packets. Thus, rather than using a static duration that is determined based on worst-case conditions, shorter IFGs may be used (where possible), reducing the IFG in the corresponding bursts and as such resulting in enhanced overall efficiency. Use of such an adaptive IFG management scheme is explained with respect to an example arrangement in FIG. 3.

FIG. 3 illustrates an example Multimedia over Coax Alliance (MoCA®) arrangement that may support and utilize adaptive inter-frame gap (IFG) reduction. Shown in FIG. 3 is an example MoCA arrangement 300.

The MoCA arrangement 300 may correspond to (at least portion of) a MoCA network, which may be substantially similar to the MoCA network 100 of FIG. 1. For example, the MoCA arrangement 300 may comprise a plurality of MoCA nodes Nᵢ 302ᵢ (e.g., network nodes N1 302₁ through N5 302₅ are shown in the particular implementation illustrated in FIG. 5) and a point of entry (e.g., splitter) 304.

The MoCA arrangement 300 may be configured to implement adaptive IFG management, to optimize (e.g., reduce where possible) IFGs (inter-frame gaps) in/between MoCA PHY packets, thus improving overall efficiency of the MoCA network.

As noted above, conventionally a static IFG duration is typically used or incorporated into packet burst transmissions in MoCA networks. In this regard, the IFG may be set to the duration determined to be sufficient for worst-case conditions (e.g., in MoCA 2.0, the IFG is 6 μs). In many instances, however, packet burst transmissions may be done successfully with shorter inter-frame gaps (IFGs). In this regard, there may be different delay requirements (between packet bursts) for different node pairs. For example, node pairs may require different delays based on their relative locations within the MoCA network—relative to one another and/or in relation to other particular elements in the network, such as points of entry (PoEs).

Therefore, to improve overall data transfer efficiency, an adaptive management scheme may be used to allow adaptively determining and/or setting IFGs separating packet bursts. Thus, rather than using the static/regular IFG duration, which may be determined based on worst-case scenario, shorter IFGs may be used (where possible). For example, in the MoCA arrangement 300 shown in FIG. 3, for example, the MoCA nodes N1 302₁, N3 302₃, and N5 302₅ are on same side of PoE splitter 304, and MoCA nodes N2 302₂ and N4 302₄ are on the other side of PoE splitter 304.

In an example adaptive IFG management scheme used in the MoCA arrangement 300, a regular IFG may be used on certain situations, whereas shorter IFGs may be determined and used in other situations. For example, regular IFG may be used for receive-transmit (Rx-Tx) turnaround (e.g., where a node needs to receive a packet and then transmits a packet before receiving the next packet) and for cross-domain turnaround (e.g., where the nodes are on different sides of a particular points of entry (PoE)). In this regard, the cross-domain turnaround may be defined, where pre-IFG propagation delay>post-IFG propagation delay+IFG_thresh (where IFG_thresh is a configurable threshold). Else, shorter IFGs may be used.

Thus, an improve burst transmission profile may be achieved (e.g., as illustrated in burst profile 320 in FIG. 3). In this regard, shorter IFGs (e.g., 324₁ and 324₂) are used between certain bursts (322₁, 322₂ and 322₃), whereas regular IFGs (e.g., 324₃) are used between certain bursts (322₃ and 322₄) meeting any of the criteria for use of regular IFG.

In an example implementation, each of the nodes may obtain ranging information corresponding to each of the other nodes in the network. This may be done using ranging methods or techniques—e.g., the ranging protocol already defined per MoCA standards, using transmit and receive timestamps. Further, to reduce or eliminate overhead of such ranging, the nodes may be configured to perform the ranging during pre-determined periods of inactivity in the network. The ranging information may be used in determining, for each node, round trip delay or time (RTT) for each other node in the network, and the round-trip delay in turn may be used in determining the propagation delay (e.g., propagation delay may be set as RTT/2). Ranging may be used, for example, to synchronize an admitting node's clock (e.g., to that of the NC), measure propagation delays (e.g., between each node and the NC), regularly maintain channel related clocking against drift (e.g., relative to that of the NC), etc. For example, the ranging may be done as part of the admission procedures and/or as part of the link maintenance procedures performed by the MoCA nodes within MoCA networks.

For example, as part of the link maintenance procedures, each node may assess in addition to channel characteristics, round-trip delays for each of the remaining nodes, based on ranging-related interactions (e.g., transmit and receive timestamps). In this regard, link maintenance procedures may be performed to ensure that optimized point-to-point and broadcast links are maintained between all nodes in the MoCA networks. Link maintenance may be performed periodically as links' characteristics may vary over time. Nonetheless, in addition to link maintenance being performed regularly (periodically), in some instances link maintenance may also be performed on-demand. During link maintenance, information relating or pertinent to the links may be obtained. For example, link maintenance may comprise recalculation of physical layer (PHY) parameters, such as modulation profile, transmit power, etc. Link maintenance may comprise receiving probes at regular intervals and sending back probe reports to the transmitting node(s). In some instances, link maintenance may comprise (re-)selecting the best node to operate as network controller (NC).

In an example implementation, the ranging information (and/or the propagation delay or round-trip delay related information, which may be determined directly based thereon by the nodes) may be reported by the nodes to the network coordinators (NC) of the MoCA network. The network coordinator may then use the reported information in determining shorter IFGs period(s) and/or in assigning any such determined shorter IFGs to particular nodes, for use thereby in transmissions to particular peers.

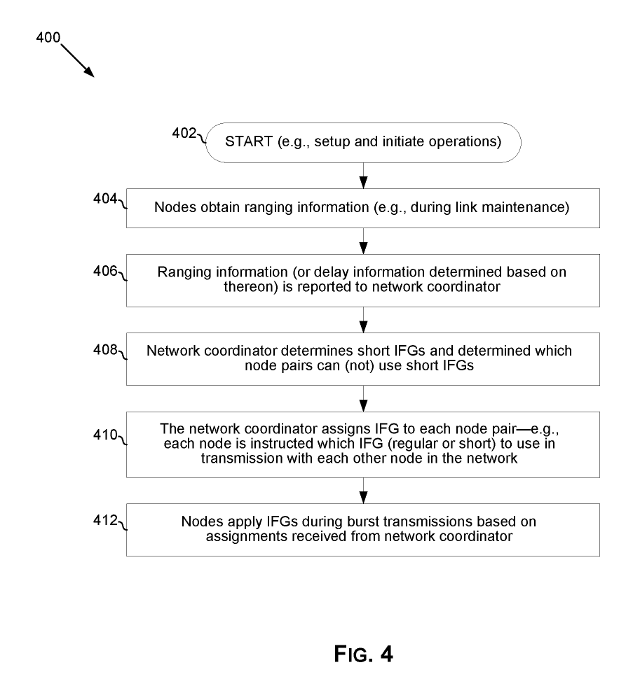

FIG. 4 illustrates a flowchart of an example process for utilizing adaptive inter-frame gap (IFG) management in a Multimedia over Coax Alliance (MoCA®) network. Shown in FIG. 4 is flow chart 400, comprising a plurality of example steps (represented as blocks 402-410), which may be performed in a suitable system (e.g., MoCA network 100 or MoCA arrangement 300) to provide adaptive IFG management.

In starting step 402, the system may be setup and initiated for operation.

In step 404, network nodes (e.g., MoCA node N1 302₁ through MoCA node N5 302₅) may obtain ranging information (e.g., during link maintenance).

In step 406, ranging information (or delay information determined based on thereon) may be reported to a network coordinator.

In step 408, the network coordinator may determine short IFGs and determine which node pairs can (not) use short IFGs.

In step 410, the network coordinator may assign an IFG to each pair of network nodes—e.g., each network node is instructed which IFG (regular or short) to use in transmission with which other network node in the network.

In step 412, the network nodes may apply IFGs adaptively during burst transmissions based on assignments received from the network coordinator.

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the processes as described herein.

Accordingly, various embodiments in accordance with the present invention may be realized in hardware, software, or a combination of hardware and software. The present invention may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip.

Various embodiments in accordance with the present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method comprising:
in a network node that is configured as network controller within a Multimedia over Coax Alliance (MoCA®) network:
receiving communication timing related information associated with each of a plurality of network nodes in said MoCA network;
assessing based on said communication timing related information, communication timing for each pair of network nodes in said plurality of network nodes; and
adaptively configuring communications between each pair of network nodes in said plurality of network nodes based on said assessing; wherein said configuring comprise adjusting timing related parameters or fields in packets.

2. The method of claim 1, wherein timing related parameters or fields comprise inter-frame gap (IFG) fields in physical layer (PHY) packets.

3. The method of claim 2, comprising selecting, when adaptively configuring said communications between each pair of network nodes, between a regular inter-IFG and a short IFG.

4. The method of claim 3, comprising selecting between said regular inter-IFG and said short IFG based on one or more of type of communication and relative location of network nodes, relative to one another and/or to other elements in said MoCA network.

5. The method of claim 1, wherein said communication timing related information comprises ranging information or ranging-based timing information determined based on said ranging information.

6. The method of claim 5, wherein said ranging-based timing information comprises propagation delay or round-trip delay.

7. The method of claim 5, comprising receiving said ranging information from each of said plurality of network nodes.

8. The method of claim 5, comprising receiving said ranging information based on transmit and receive timestamps embedded into communicated packets.

9. The method of claim 5, receiving a report of said ranging-based timing information, wherein said ranging-based timing information in a particular network node is determined based on associated ranging information.

10. The method of claim 5, comprising receiving in said network controller, ranging information from a particular network node, and determining said ranging-based timing information associated with said particular network node based on said received ranging information.

11. A system comprising:
a network node that is configured as network controller within a Multimedia over Coax Alliance (MoCA®) network, said network node comprising:
one or more communication circuits operable to receive a plurality of signals each respectively from a plurality of network nodes in said MoCA network, wherein each said plurality of signals report communication timing related information associated with a corresponding one of plurality network nodes; and
one or more processing circuits operable to:
assess based on said communication timing related information, communication timing for each pair of nodes in said plurality of network nodes; and
adaptively configure communications between each pair of nodes in said plurality of network nodes based on said assessing, wherein said configuring comprises adjusting timing related parameters or fields in communicated packets.

12. The system of claim 11, wherein timing related parameters or fields comprise inter-frame gap (IFG) fields in physical layer (PHY) packets.

13. The system of claim 12, wherein said one or more processing circuits are operable to select, when adaptively configuring said communications between each pair of network nodes, between a regular inter-IFG and a short IFG.

14. The system of claim 13, wherein one or more processing circuits are operable to select between said regular inter-IFG and said short IFG based on one or more of type of communication and relative location of network nodes, relative to one another and/or to other elements in said MoCA network.

15. The system of claim 11, wherein said communication timing related information comprises ranging information or ranging-based timing information determined based on said ranging information.

16. The system of claim 15, wherein said one or more processing circuits are operable to, when receiving ranging information from particular network node, determine said ranging-based timing information associated with said particular network node based on said received ranging information.

17. A system comprising:
a network node within a Multimedia over Coax Alliance (MoCA®) network, said network node comprising:
one or more communication circuits operable to transmit and receive signals to two or more other network nodes in said MoCA network, including a network controller; and
one or more processing circuits operable to:
receive from said network controller signals providing instructions for adaptively configuring communications with other network nodes, wherein said adaptive configuring comprises adjusting timing related parameters or fields in communicated packets based on communication timing related information reported to said network controller; and
configuring communications with said other network nodes based on said instructions.

18. The system of claim 17, wherein timing related parameters or fields comprise inter-frame gap (IFG) fields in physical layer (PHY) packets.

19. The system of claim 18, wherein said adaptive configuring comprises setting IFG in each packet, based on said instructions to regular value or shorten value.

20. The system of claim 17, wherein said communication timing related information comprises ranging information or ranging-based timing information determined based on said ranging information.

21. The system of claim 20, wherein said one or more processing circuits are operable to obtain said ranging-based timing information from said ranging information, and said ranging-based timing information is then reported to said network controller via signals communicated via said one or more communication circuits.
